(19) United States
(12) Patent Application Publication
(10) Pub. No.: US 2012/0307157 A1
(43) Pub. Date: Dec. 6, 2012

(54) AUDIO/VIDEO DEVICE AND AUDIO/VIDEO SYSTEM COMPRISING SAME

(75) Inventor: Tokuaki UTSUNOMIYA, Daito-shi (JP)

(73) Assignee: FUNAI ELECTRIC CO., LTD., Osaka (JP)

(21) Appl. No.: 13/478,439

(22) Filed: May 23, 2012

(30) Foreign Application Priority Data
May 31, 2011 (JP) 2011-121698

(51) Int. Cl. H04N 5/14

(52) U.S. Cl. 348/707; 348/E05.096

(57) ABSTRACT

In an audio/video system, an audio/video device including a signal amplifier, and an external device are connected via an HDMI cable, and the audio of the audio/video device or the external device is output from an audio output device. When there is a change in a specified state of the external device, if operation setting information has not been set to activate a system audio control function or to indicate start-up in an external input mode, then this function is deactivated, and the audio/video device is started up as a content reproduction device; and if the operation setting information has been set to activate the system audio control function and to indicate start-up in the external input mode, then this function is activated, and the audio/video device is started up as an audio amplification device.

### BACKGROUND OF THE INVENTION

1. Field of the Invention

The present invention relates to an audio/video device that is compatible with the HDMI standard and an audio/video system including such an audio/video device.

2. Description of the Related Art

An audio/video system has been known in the past in which the audio output of an audio/video device, such as a television set and an optical disk device, was amplified by an amplifier device and output from a dedicated audio speaker in order to enjoy higher-quality audio output with more impact. With such an audio/video system, the audio/video device, such as a television set and an optical disk device, is connected on the input side of the amplifier device, and the audio speaker is connected on the output side. Furthermore, if the amplifier device is built into the audio speaker, the audio/video device, such as a television set and optical disk device, is connected directly to the audio speaker.

Meanwhile, in recent years, optical disk devices with built-in amplifier devices have also become popular, and there are also audio/video systems in which audio is output from the audio speaker after the audio of the content reproduced by the optical disk or the audio from the television set has been amplified by the amplifier device of the optical disk device. With this audio/video system, devices such as the television set and an optical disk device are compatible with the HDMI (high definition multimedia interface) standard, and the television set and the optical disk device are connected by an HDMI cable, while the audio speaker is connected to the audio output terminal of the optical disk device.

In this audio/video system, a CEC (consumer electronics control) function of the HDMI standard is used to enable control through interactions between the television set and the optical disk device connected to each other by the HDMI cable. Therefore, if the CEC function is utilized, switching of the audio output between the television set and the optical disk device, adjustment of the volume of the audio output, switching of the power on or off to all of the audio/video devices connected to each other by the HDMI cable, and the like can be performed by remote control.

With the system in Japanese Patent Application Laid-Open Publication No. 2010-41203, for example, the volume adjustment of a monitor and an external device (a tuner or an optical disk device) connected by HDMI can be performed by remote control. Moreover, with the audio/video system disclosed in Japanese Patent Application Laid-Open Publication No. 2009-100329, the TV remote control can be used to automatically switch video and audio to the input from an optical disk reproduction device when the user wants to reproduce from an optical disk reproduction device while watching television, or to switch the power on or off on the optical disk reproduction device. In addition, with the communication system described in PCT International Application No. WO2008/056707, a remote control can be used to select the television channel, to perform one-touch recording of a broadcast program while the user is watching television, or to switch the audio output to “theater mode” (audio output from a group of speakers connected to an audio amplifier).

### SUMMARY OF THE INVENTION

With the HDMI standard, however, when one-touch actuation of a television set or optical disk device, a channel change of the television set, or the like is performed by utilizing a CEC function, because it is not clearly defined as to the function of which of the devices should be given priority, the system may perform an operation that is not intended by the user. For example, when the user performs one-touch actuation of the television set or inputs an operation to change the channel while watching television, there may be a situation in which the optical disk device automatically starts up as a content reproduction device, the audio output of that content is given priority, and the television audio is not output from the audio speaker.

To counter this, in Japanese Patent Application Laid-Open Publication No. 2010-41203, when a monitor is actuated, whether to output audio on the monitor side or on an external device side is decided by whether or not the connection of the external device can be recognized. Furthermore, in Japanese Patent Application Laid-Open Publication No. 2009-100329, whether to output audio from the television or from an amplifier device is decided by a request of an optical disk reproduction device. However, with Japanese Patent Application Laid-Open Publication No. 2010-41203 and Japanese Patent Application Laid-Open Publication No. 2009-100329, the user cannot freely select the device that is to output the audio. Moreover, in PCT International Application No. WO 2008/056707, the state in which the optical disk device starts up is not clearly established during a channel change or the one-touch actuation of the television set.

Preferred embodiments of the present invention were devised in light of the aforementioned problems, and provide an audio/video device which can be actuated in the state intended by the user by utilizing an HDMI-CEC function, as well as an audio/video system including such an audio/video device.

An audio/video device according to a preferred embodiment of the present invention is an HDMI-compatible audio/video device including a content reproduction device that reads content from a removable storage medium or a built-in storage device; a signal amplification device that amplifies an audio signal and outputs an amplified audio signal to an audio output device; an audio processor that extracts audio information from the content read by the content reproduction device and outputs it as a first audio signal; an HDMI communication device which communicates with an external device connected via an HDMI cable; a storage device that stores operation setting information to set an operating mode at start-up and to determine whether to activate or deactivate a system audio control function defined in the HDMI standard; and a CEC controller arranged such that when the HDMI communication unit receives a preset CEC command that is output from the external device when there is a change in a specified state of the external device, if the operation setting information has not been set to activate the system audio control function or to indicate start-up in an external input mode in which a second audio signal that is input from the external device to the HDMI communication unit is input in the signal amplification device, then the CEC controller deactivates the system audio control function and starts up the device as a content reproduction device, and if the operation setting information has been set to activate the system audio control function and to indicate start-up in the external input mode, then the CEC controller activates the system audio control function and starts up the device as an audio amplification device.

With the aforementioned configuration, when there is a change in a specified state of the external device, if the operation setting information has not been set to activate the system audio control function defined in the HDMI (high definition multimedia interface) standard or to indicate start-up in an external input mode in which a second audio signal that is input from the external device is input to the signal amplification device, then the system audio control function is deactivated, and the audio/video device is started up as a content reproduction device, and if the operation setting information has been set to activate the system audio control function or to indicate start-up in an external input mode, then the system audio control function is activated, and the audio/video device is started up as an audio amplification device. Because of this, it is possible to use the operation setting information to preset whether the audio/video device is to be utilized as a content reproduction device or to be utilized as an amplification device for an externally input audio signal when there is a change in a specified state of the external device. Accordingly, the audio/video device can be started up in the state intended by the user by utilizing the HDMI-CEC (high definition multimedia interface-consumer electronics control) function.

Note that the HDMI-CEC function is a function whereby, when an HDMI cable is used to connect between devices that are compatible with HDMI, mutual control of the two devices is realized through interactions as a result of the two devices sending and receiving control signals called CEC commands via the HDMI cable.

In the aforementioned configuration, the change in the specified state of the external device may be the start-up of the external device, or the external device may be a television receiver, and the change in the specified state of the external device may be a channel change of a broadcast signal received by the television receiver, for example.

Furthermore, in the aforementioned configuration, the audio/video device may further include a switching device that switches the audio signal to be output to the signal amplification device on the basis of a control signal that is input from the CEC controller, and when the HDMI communication device receives the preset CEC command, the CEC controller may output to the switching device a first control signal to output the first audio signal from the switching device to the signal amplification device if the operation setting information has not been set to activate the system audio control function or to indicate start-up in the external input mode, and the CEC controller may output to the switching device a second control signal to output the second audio signal from the switching device to the signal amplification device if the operation setting information has been set to activate the system audio control function and to indicate start-up in the external input mode.

With this configuration, when there is a change in a specified state of the external device, it is possible to preset by the operation setting information whether the first audio signal extracted from the content read from a removable storage medium or a built-in storage device, or the second audio signal externally input from the external device via an HDMI cable will be output from the switching device to the signal amplification device.

Moreover, an audio/video device according to a preferred embodiment of the present invention preferably is an HDMI-compatible audio/video device that includes a content reproduction device that reads content from a removable storage medium or a built-in storage device; a signal amplification device that amplifies an audio signal and outputs it to an audio output device; and an audio processor that extracts audio information from the content read by the content reproduction device and outputs it as a first audio signal, wherein the audio/video device also includes an HDMI communication device that communicates with an external device connected via an HDMI cable; a storage device that stores operation setting information to set the operating mode at start-up and to determine whether to activate or deactivate a system audio control function defined in the HDMI standard; and a CEC controller that performs control such that when the HDMI communication device receives a preset CEC command that is output from the external device when there is a change in a specified state of the external device, if the operation setting information has not been set to activate the system audio control function or to indicate start-up in an external input mode in which a second audio signal that is input from the external device to the HDMI communication device is input in the signal amplification device, then the CEC controller deactivates the system audio control function and starts up the device as a content reproduction device, and if the operation setting information has been set to activate the system audio control function and to indicate start-up in the external input mode, then the CEC controller activates the system audio control function and starts up the device as an audio amplification device.

With the aforementioned configuration, when there is a change in a specified state of the external device, if the operation setting information has not been set to activate the system audio control function defined in the HDMI standard or to indicate start-up in an external input mode in which a second audio signal that is input from the external device is input in the signal amplification device, then the system audio control function is deactivated, and the audio/video device is started up as a content reproduction device, and if the operation setting information has been set to activate the system audio control function and to indicate start-up in the external input mode, then the system audio control function is activated, and the audio/video device is started up as an audio amplification device. Therefore, when there is a change in a specified state of the external device, the operation setting information makes it possible to preset whether the audio/video device is to be utilized as a content reproduction device or to be utilized as an amplifier device for an externally input audio signal. Accordingly, the HDMI-CEC function can be utilized to start up the audio/video device in the state intended by the user.

In addition, an audio/video system according to a preferred embodiment of the present invention includes an audio/video device according to a preferred embodiment of the present invention described above; an HDMI-compatible external device connected to the audio/video device; and an audio output device that outputs audio of the audio/video device or the external device.

With the aforementioned configuration, when there is a change in a specified state of the external device, if the operation setting information has not been set to activate the system audio control function defined in the HDMI standard or to indicate start-up in an external input mode in which a second audio signal that is input from the external device is input in the signal amplification device, then the system audio control function is deactivated, and the audio/video device is started up as a content reproduction device, and if the operation setting information has been set to activate the system audio control function and to indicate start-up in the external input mode, then the system audio control function is activated, and the audio/video device is started up as an audio amplification device. Therefore, when there is a change in a specified state of the external device, the operation setting information makes it possible to preset whether the audio/video device is to be utilized as a content reproduction device or to be utilized as an amplifier device for an externally input audio signal. Accordingly, the HDMI-CEC function can be utilized to start up the audio/video device in the state intended by the user.

With various preferred embodiments of the present invention, when there is a change in a specified state of the external device, if the operation setting information has not been set to activate the system audio control function defined in the HDMI standard or to indicate start-up in an external input mode in which a second audio signal that is input from the external device is input in the signal amplification device, then the system audio control function is deactivated, and the audio/video device is started up as a content reproduction device, and if the operation setting information has been set to activate the system audio control function and to indicate start-up in the external input mode, then the system audio control function is activated, and the audio/video device is started up as an audio amplification device. Therefore, when there is a change in a specified state of the external device, the operation setting information makes it possible to preset whether the audio/video device is to be utilized as a content reproduction device or to be utilized as an amplifier device for an externally input audio signal. Accordingly, the HDMI-CEC function can be utilized to start up the audio/video device in the state intended by the user.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a diagram of the configuration of the audio/video system according to a preferred embodiment of the present invention.

FIG. 2 is a flowchart of the operation during start-up of an optical disk device.

### DETAILED DESCRIPTION OF THE PREFERRED EMBODIMENTS

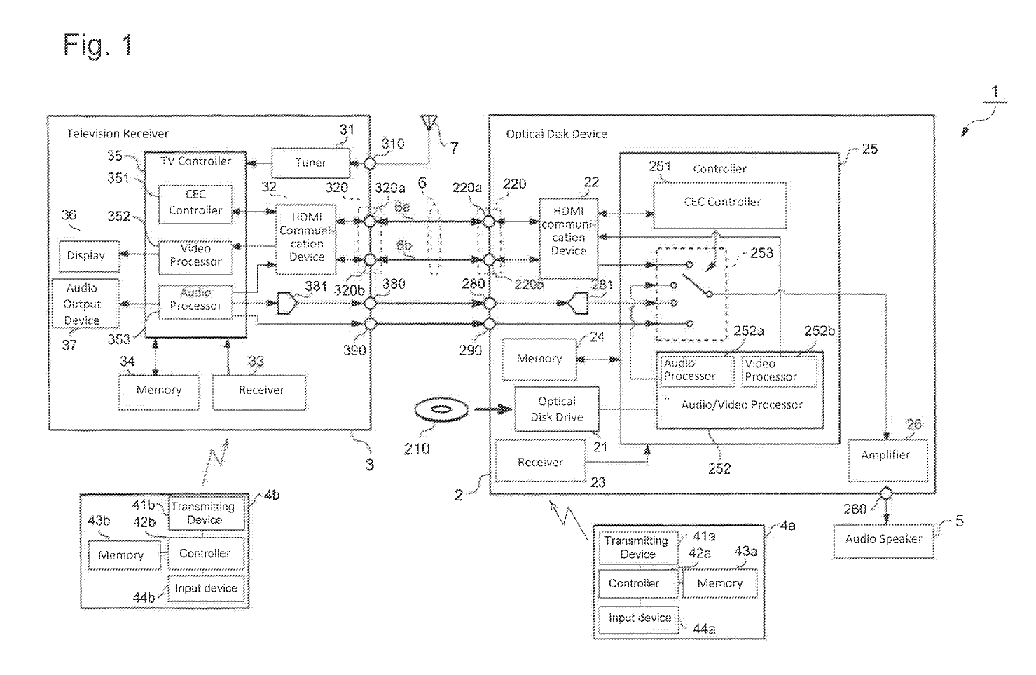

Preferred embodiments of the present invention will be described below with reference to the drawings. FIG. 1 is a diagram of the configuration of the audio/video system of the present preferred embodiment. An audio/video system 1 preferably includes an optical disk device 2 (audio/video device), a television receiver 3 (hereinafter referred to as a television), and an audio speaker 5 (audio output device). The optical disk device 2 and the television 3 are respectively equipped with remote controls 4a and 4b that are used by the user for input operation. Note that the present invention is not limited to the configuration shown in FIG. 1, and other audio/video devices may also be connected to the audio/video system 1, for example.

The optical disk device 2 and the television 3 preferably are both audio/video devices that are compatible with the HDMI standard. Therefore, with the audio/video system 1, the optical disk device 2 and the television 3 can control each other through interactions via an HDMI-CEC function. Here, the HDMI-CEC (high definition multimedia interface-consumer electronics control) function is a function whereby, when an HDMI cable 6 is used to connect HDMI-compatible devices to each other, mutual control of the two devices is realized through interactions as a result of the two devices sending and receiving control signals called CEC commands via the HDMI cable 6. The operation of each device included in the audio/video system 1 can be performed with the remote controls 4a and 4b by utilizing the HDMI-CEC function. The user can also use just the remote control 4a of the optical disk device 2 to perform the operation of the optical disk device 2 and television 3, or can also use just the remote control 4b of the television 3 to perform the operation of the optical disk device 2 and television 3.

Furthermore, with the audio/video system 1, if the system audio control function is utilized, when the user is to view the content stored on an optical disk 210 such as a DVD, an image of the content reproduced by the optical disk device 2 can be displayed on the television 3, and the audio can be output from the audio speaker 5. Moreover, when the user wants to view a broadcast program, the video of the broadcast program received by the television 3 can be displayed on the television 3, and the audio of this broadcast program can also be amplified by utilizing the amplifier function of the optical disk device 2 to output high-quality and impressive audio from the audio speaker 5.

Note that with the HDMI standard, when audio output is performed by another audio/video device (the optical disk device 2 in this case), it is determined that the audio output from the device itself (the television 3 in this case) is muted. Because of this, when the audio of the television 3 is output from the audio speaker 5 utilizing the amplifier function of the optical disk device 2, no audio is output from the television 3 itself.

In addition, the optical disk device 2 and the television 3 are connected via the HDMI cable 6. The HDMI cable 6 includes a control signal line 6a that sends and receives CEC control signals in order to utilize the HDMI-CEC function and an audio/video signal line 6b that propagates video and audio signals.

Next, the configuration of the optical disk device 2 will be described. The optical disk device 2 includes an optical disk drive 21 (content reproduction device), an HDMI communication device 22, a receiver device 23, a memory 24 (storage device), a controller 25, and an amplifier 26 (signal amplification device). The controller 25 includes a CEC controller 251, an audio/video processor 252, and a switching device 253. Furthermore, the optical disk device 2 is provided with an HDMI terminal 220, an audio output terminal 260, an analog audio terminal 280, an A/D converter 281, and a digital audio terminal 290. In addition, the optical disk device 2 may also include an HDD or other such storage device (built-in storage device) or a content recording device (such as an optical disk drive that can write information to the optical disk 210) with which information can be written to the optical disk 210 or another such removable recording medium.

The HDMI terminal 220 is an external connection terminal to which the HDMI cable 6 is connected in order to communicate with an external device that is compatible with the HDMI standard, and preferably includes a plurality of terminals including an HDMI control terminal 220a and an HDMI audio/video terminal 220b. The HDMI control terminal 220a sends and receives CEC control signals (hereinafter referred to as CEC commands) to mutually control the television 3 and the optical disk device 2. The HDMI audio/video terminal 220b inputs and outputs audio/video signals in which video signals and audio signals are superimposed.

The audio output terminal 260 is an output terminal that externally outputs the audio signal that is output from the amplifier 26. Moreover, analog audio signals are input from the outside to the analog audio terminal 280. The analog audio signals that are input to the analog audio terminal 280 are converted into digital signals by the A/D converter 281. In addition, digital audio signals are input from the outside to the digital audio terminal 290. Digital audio signals converted by the A/D converter 281 and digital signals input to the digital audio terminal 290 are output to the switching device 253.

The optical disk drive 21 preferably is a content reproduction device that reads content from the optical disk 210 (removable storage medium) and outputs the content as a reproduction signal.

The HDMI communication device 22 is an interface to provide communication with the television 3 via the HDMI cable 6 connected to the HDMI terminal 220. The HDMI communication device 22 outputs, from the HDMI control terminal 220a to the television 3 via the HDMI cable 6, a CEC command that is input from the CEC controller 251, and outputs to the CEC controller 251 a CEC command that is input from the television 3 to the HDMI control terminal 220a via the HDMI cable 6. Furthermore, the HDMI communication device 22 superimposes the video signal that is output from a video processor 252b with the transmission signals sent and received between the optical disk device 2 and the television 3, and outputs the superimposed signals as the audio/video signal from the HDMI audio/video terminal 220b to the television 3 via the HDMI cable 6. Moreover, the HDMI communication device 22 extracts an audio signal (second audio signal) from the audio/video signal that is input from the television 3 to the HDMI audio/video terminal 220b via the HDMI cable 6, and outputs the extracted audio signal (second audio signal) to the switching device 253.

The receiver 23 receives an infrared signal from the remote control 4a, extracts an operation code from the infrared signal, and outputs the operation code to the controller 25.

The memory 24 preferably is a nonvolatile recording medium. The memory 24 stores programs, control information (such as CEC commands or data tables indicating the corresponding relationship between various operation codes and various functions), and the like which are required for the controller 25 and the CEC controller 251 to perform control of an external device (here, the television 3) connected to the optical disk device 2 or the various components of the optical disk device 2.

In addition, the memory 24 stores operation setting information to set the operating mode at start-up of the optical disk device 2 and whether to activate or deactivate the system audio control function defined in the HDMI standard. When an input operation to the remote control 4a or remote control 4b is performed to start up the optical disk device 2 or television 3, or when a preset CEC command such as “system audio mode request” is input to the optical disk device 2 from the television 3 via the HDMI cable 6, on the basis of the operation setting information, the on/off switching of the system audio control function is set at the optical disk device 2, and whether to start up the optical disk device 2 as an amplifier device (audio amplification device) or to start it up as a player (content reproduction device) is also set. Note that the operation setting information may also be information to set the audio signal that is output from the switching device 253 to the amplifier 26 instead of the operating mode at the start-up of the optical disk device 2.

The operation setting information can be used to preset whether the optical disk device 2 is to start up in content reproduction mode and to function as an optical disk player (content reproduction device), or, with the system audio control function being activated, the optical disk device 2 is to start up in external input mode and to function as an amplifier device (audio amplification device) that amplifies an externally input audio signal, when there is a change in a specified state of the television 3 (such as the start-up of the television 3 or a channel change). Accordingly, the optical disk device 2 can be started up in the state intended by the user by utilizing the HDMI-CEC function. This operation setting information can be created and modified by function setting on the menu screen of the optical disk device 2, for example.

The controller 25 utilizes programs stored in the memory 24 or in a ROM (not illustrated) built into the controller 25 to control the overall operation of the optical disk device 2 in accordance with the control information stored in the memory 24 or operation codes output from the receiver 23.

The CEC controller 251 controls the optical disk device 2 through interactions with the television 3 on the basis of CEC commands exchanged with the television 3 via the HDMI cable 6. For instance, when the HDMI communication device 22 receives a preset CEC command (such as “system audio mode request”) that is output from the television 3 when there is a change in a specified state of the television 3 (such as the start-up of the television 3 or a channel change) by input operation with the remote control 4b of the television 3, if the operation setting information has not been set to activate the system audio control function or to indicate start-up in an external input mode, which will input to the amplifier 26 the audio signal (second audio signal) that is input from the television 3 to the HDMI communication device 22, then the CEC controller 251 deactivates the system audio control function and starts up the device as a content reproduction device. Alternatively, if the operation setting information is set to activate the system audio control function and to indicate start-up in an external input mode, then the system audio control function is activated, and the device is started up as an audio amplification device.

At this point, furthermore, the CEC controller 251 controls the switching operation of the audio signal to be output to the amplifier 26 by the switching device 253 and decides whether the audio signal that is input from the television 3 to the HDMI communication device 22 (second audio signal) or the audio signal extracted from content read by the optical disk drive 21 (first audio signal) will be output to the amplifier 26. Then, the CEC controller 251 edits the operation setting information and overwrites it in the memory 24 on the basis of these decision results. Moreover, in cases where the operation setting information has not been set to activate the system audio control function or to indicate start-up in an external input mode, the CEC controller 251 outputs to the switching device 253 a first control signal to output the first audio signal from the switching device 253 to the amplifier 26. Alternatively, in cases where the operation setting information has been set to activate the system audio control function and to indicate start-up in an external input mode, a second control signal to output the second audio signal from the switching device 253 to the amplifier 26 is output to the switching device 253.

Similarly, in cases where a preset CEC command to change a specified state of the television 3 (such as start-up of the television 3 or a channel change) is output from the HDMI communication device 22 to the television 3 by input operation with the remote control 4a of the optical disk device 2 or the like as well, the CEC controller 251 sets the on/off switching of the system audio control function in the optical disk device 2 and starts up the optical disk device 2 as an amplifier device or a content reproduction device on the basis of the operation setting information stored in the memory 24. At this point, furthermore, the CEC controller 251 controls the switching operation of the audio signal to be output to the amplifier 26 by the switching device 253, and decides whether the audio signal that is input from the television 3 to the HDMI communication device 22 (second audio signal) or the audio signal extracted from content read by the optical disk drive 21 (first audio signal) will be output to the amplifier 26. Then, the CEC controller 251 edits the operation setting information and overwrites it in the memory 24 on the basis of these decision results. Moreover, the CEC controller 251 outputs to the switching device 253 a control signal to output either the second audio signal or the first audio signal to the amplifier 26, on the basis of the operation setting information stored in the memory 24.

The audio/video processor 252 preferably includes an audio processor 252a and a video processor 252b. The audio processor 252a extracts audio information from content read by the optical disk drive 21 and outputs this audio information as an audio signal (first audio signal) to the switching device 253. In addition, the video processor 252b extracts video information from content read by the optical disk drive 21 and outputs this video information as a video signal to the HDMI communication device 22.

The switching device 253 switches, on the basis of a control signal that is input from the CEC controller 251, the audio signal to be output to the amplifier 26 to one of an audio signal externally input from the television 3 via the HDMI cable (second audio signal), an audio signal that is output from the audio processor 252a (first audio signal), an analog audio signal externally input from the television 3 and converted into a digital signal by the A/D converter 281, and a digital audio signal externally input from the television 3. For example, when the HDMI communication device 22 receives a preset CEC command from the television 3, or when a preset CEC command is sent from the HDMI communication device 22 to the television 3, the switching device 253 outputs either the second audio signal or the first audio signal to the amplifier 26 on the basis of a control signal that is output from the CEC controller 251.

The amplifier 26 amplifies the audio signal that is input from the switching device 253 and outputs the amplified audio signal from the audio output terminal 260 to the audio speaker 5.

In addition, the remote control 4a that is an accessory to the optical disk device 2 preferably includes a transmitting device 41a, a controller 42a, a memory 43a which preferably is a nonvolatile recording medium, and an input device 44a including a plurality of operation keys. The input device 44a inputs to the controller 42a a command signal corresponding to user operated input. The controller 42a refers to a data table stored in the memory 43a and inputs to the transmitting device 41a an operation code corresponding to the command signal. The data table stored in the memory 43a is a data table indicating the corresponding relationship between the operation codes and the command signals output from the input device 44a. The transmitting device 41a superimposes the operation code received from the controller 42a with a carrier wave signal, converts the product of superimposing into an infrared signal, and outputs the resulting signal.

Next, the configuration of the television 3 will be described. The television 3 preferably includes a tuner 31, an HDMI communication device 32, a receiver 33, a memory 34, a TV controller 35, a display 36, and an audio output 37. Note that the TV controller 35 preferably includes a CEC controller 351, a video processor 352, and an audio processor 353. In addition, the television 3 preferably includes a tuner terminal 310, an HDMI terminal 320, an analog audio terminal 380, a D/A converter 381, and a digital audio terminal 390.

The HDMI terminal 320 is an external connection terminal to which the HDMI cable 6 is connected in order to communicate with an external device that is compatible with the HDMI standard, and preferably includes a plurality of terminals including an HDMI control terminal 320a and an HDMI audio/video terminal 320b. The HDMI control terminal 320a sends and receives CEC control signals (hereinafter referred to as CEC commands) to mutually control the television 3 and the optical disk device 2. The HDMI audio/video terminal 320b inputs and outputs audio/video signals in which video signals and audio signals are superimposed.

An antenna 7 is connected to the tuner terminal 310, and broadcast waves received by the antenna 7 are input as an electrical signal. Furthermore, an analog audio signal converted by the D/A converter 381 is output from the analog audio terminal 380 to the outside. Moreover, a digital audio signal is output from the digital audio terminal 390 to the outside.

The tuner 31 is connected to the antenna 7 via the tuner terminal 310, and a broadcast signal is extracted from the radio signal received by the antenna 7, subjected to decoding and demodulation, and output to the TV controller 35.

The HDMI communication device 32 is an interface that communicates with the optical disk device 2 via the HDMI cable 6 connected to the HDMI terminal 320. The HDMI communication device 32 outputs, from the HDMI control terminal 320a to the optical disk device 2 via the HDMI cable 6, a CEC command that is output from the CEC controller 351, and outputs to the CEC controller 351 a CEC command that is input from the optical disk device 2 to the HDMI control terminal 320a via the HDMI cable 6. In addition, the HDMI communication device 32 extracts a video signal from the audio/video signal that is input from the optical disk device 2 to the HDMI audio/video terminal 320b via the HDMI cable 6, and outputs the extracted video signal to the video processor 352. Furthermore, the HDMI communication device 32 superimposes the audio signal that is output from the audio processor 353 (second audio signal) with the transmission signals sent and received between the optical disk device 2 and the television 3, and outputs the product of the superimposing as the audio/video signal from the HDMI audio/video terminal 320b to the optical disk device 2 via the HDMI cable 6.

The receiver 33 receives an infrared signal from the remote control 4b, extracts an operation code from the infrared signal, and outputs the operation code to the TV controller 35.

The memory 34 preferably is a nonvolatile recording medium. The memory 34 stores programs, control information (such as CEC commands or data tables indicating the corresponding relationship between various operation codes and various functions), and the like that are required to control an external device (for example, the optical disk device 2) connected to the television 3 or the various components of the television 3.

In addition, the memory 34 stores TV operation setting information to switch the system audio control function on and off and set the video output mode and audio output mode of the television 3. When there is an input operation to the remote control 4a or remote control 4b to start up the optical disk device 2 or television 3, or when a preset CEC command such as “system audio mode request” is input from the optical disk device 2 to the television 3 via the HDMI cable 6, on the basis of the TV operation setting information, the on/off switching of the system audio control function is set at the television 3, and whether to output audio from the audio output device 37 or to externally output an audio signal from the HDMI communication device 32 via the HDMI cable 6 to the optical disk device 2 is also set. Note that the TV operation setting information can be created and modified by function setting on the menu screen of the television 3, for example.

The TV controller 35 controls the overall operation of the television 3 in accordance with the control information stored in the memory 34 or operation codes output from the receiver 33 by utilizing programs stored in the memory 34 or in a ROM (not illustrated) built into the TV controller 35.

The CEC controller 351 controls the television 3 through interactions with the optical disk device 2 on the basis of CEC commands exchanged with the optical disk device 2 via the HDMI cable 6. For instance, a preset CEC command is output to the optical disk device 2 when there is a change in a specified state of the television 3 (such as the start-up of the television 3 or a channel change) by input operation with the remote control 4b of the television 3. At this point, furthermore, the CEC controller 351 outputs to the audio processor 353 a control signal to output the audio signal to be output by the audio processor 353 to either the HDMI communication device 32 or the audio output device 37 on the basis of the TV operation setting information stored in the memory 34.

Moreover, in cases where a preset CEC command to change a specified state of the television 3 (such as the start-up of the television 3 or a channel change) is input from the optical disk device 2 to the HDMI communication device 32 by input operation with the remote control 4a of the optical disk device 2 as well, the CEC controller 351 decides whether to output the audio signal output by the audio processor 353 to the HDMI communication device 32 or to the audio output device 37 on the basis of the TV operation setting information stored in the memory 34. Then, the CEC controller 351 edits the TV operation setting information and overwrites it in the memory 34 on the basis of these decision results. Furthermore, the CEC controller 351 inputs to the audio processor 353 a control signal to output the audio signal to be output by the audio processor 353 to either the HDMI communication device 32 or the audio output device 37 on the basis of the TV operation setting information stored in the memory 34. Note that if it is decided that the audio signal that is output by the audio processor 353 shall be output to the HDMI communication device 32, the CEC controller 351 mutes the audio output of the audio output device 37.

In addition, the CEC controller 351 controls the television 3 through interactions with the optical disk device 2 on the basis of CEC commands exchanged with the optical disk device 2 via the HDMI cable 6. For example, when the HDMI communication device 32 receives a preset CEC command to change a specified state of the television 3 (such as the start-up of the television 3 or a channel change) by input operation with the remote control 4a of the optical disk device 2, the audio output mode of the television 3 and whether the system audio control function is on or off are set in the television 3 on the basis of the TV operation setting information stored in the memory 34. At this point, furthermore, the CEC controller 351 decides whether to output, from the video processor 352 to the display 36, a broadcast signal or the audio/video signal that is input from the optical disk device 2 to the HDMI communication device 32. Then, the CEC controller 351 edits the TV operation setting information and overwrites it in the memory 34 on the basis of these decision results. Moreover, the CEC controller 351 inputs to the video processor 352 a control signal to output to the display a video signal extracted from either the audio/video signal or broadcast signal on the basis of the TV operation setting information stored in the memory 34.

Furthermore, when there is a change in a specified state of the television 3 (such as the start-up of the television 3 or a channel change) by input operation with the remote control 4b of the television 3, the CEC controller 351 outputs a preset CEC command (such as “system audio mode request”) from the HDMI communication device 32 to the optical disk device 2, after which the same control as described above is performed.

The audio processor 353 extracts an audio signal from the broadcast signal that is output from the tuner 31. The extracted audio signal is output to one of the HDMI communication device 32, the audio output device 37, the D/A converter 381, and the digital audio terminal 390 on the basis of the control signal output from the CEC controller 351. For example, when the HDMI communication device 32 receives a preset CEC command from the optical disk device 2, or when a preset CEC command is sent from the HDMI communication device 32 to the optical disk device 2, the audio processor 353 outputs an audio signal to either the HDMI communication device 32 or the audio output device 37 on the basis of the control signal that is output from the CEC controller 351.

The video processor 352 extracts a video signal from the broadcast signal that is output from the tuner 31. Moreover, a video signal is input from the HDMI communication device 32 to the video processor 352. This video signal preferably includes video information extracted from the content read by the optical disk device 2, and is input from the optical disk device 2 to the television 3 via the HDMI cable 6. The video processor 352 outputs to the display 36, on the basis of the control signal output from the CEC controller 351, either the video signal that is input from the optical disk device 2 to the HDMI communication device 32 or the video signal that is extracted from the broadcast signal.

The display 36 performs display on the basis of the video signal output from the video processor 352. In addition, the audio output device 37 performs audio output based on the audio signal output from the audio processor 353. Note that in cases where the audio signal that is output from the audio processor 353 is output to the HDMI communication device 32, the CEC controller 351 mutes the audio output at the audio output device 37 on the basis of the HDMI standard.

Furthermore, the remote control 4b that is an accessory to the television 3 preferably includes a transmitting device 41b, a controller 42b, a memory 43b which preferably is a nonvolatile recording medium, and an input device 44b preferably including a plurality of operation keys. The input device 44b inputs to the controller 42b a command signal corresponding to user operated input. The controller 42b refers to a data table stored in the memory 43b and inputs to the transmitting device 41b an operation code corresponding to the command signal. The data table stored in the memory 43b is a data table indicating the corresponding relationship between the operation codes and the command signals output from the input device 44b. The transmitting device 41b superimposes the operation code received from the controller 42b with a carrier wave signal, converts the product of the superimposing into an infrared signal, and outputs the resulting infrared signal.

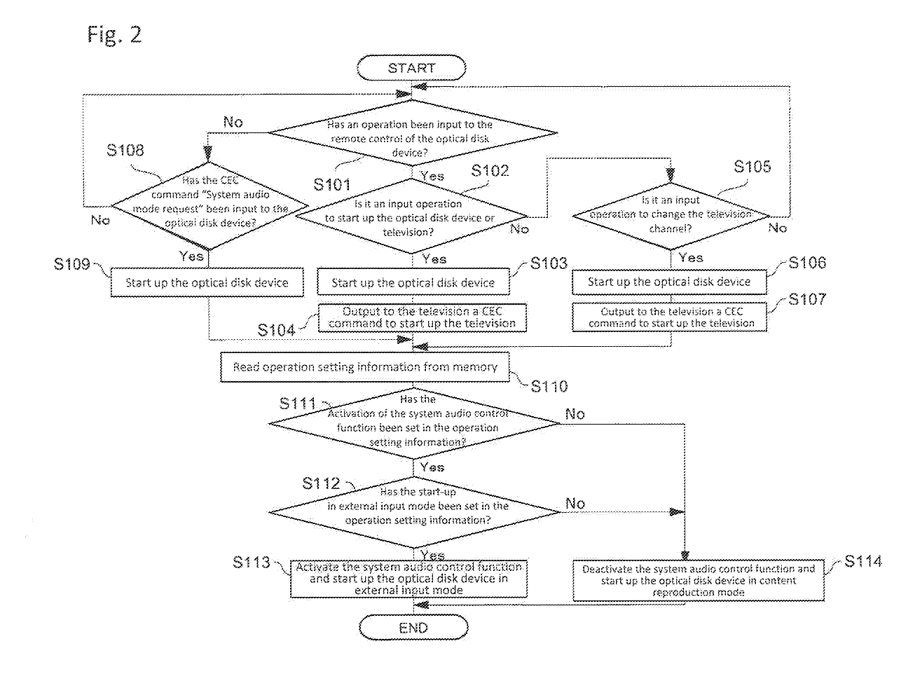

Next, the operation of starting up the optical disk device 2 in the audio/video system 1 will be described. FIG. 2 is a flowchart of the operation during start-up of the optical disk device. Note that the power to the optical disk device 2 is off at the starting point in the flowchart of FIG. 2.

First, when an operation is input to the remote control 4a that is an accessory to the optical disk device 2 (Yes in step S101), the controller 25 determines whether or not this input operation is to turn on the power to the optical disk device 2 or the television 3 (step S102). If the input operation is to turn on the power (Yes in step S102), the CEC controller 251 turns on the power to the optical disk device 2 (step S103), outputs to the HDMI communication device 22 a CEC command indicating start-up of the television 3 (step S104), and advances the processing to step S110. This CEC command is output from the HDMI control terminal 220a to the television 3 via the control signal line 6a of the HDMI cable 6. At this point, if the television 3 has not started up, power to the television 3 is switched on, and the television 3 starts up.

Moreover, if the input operation is not to turn on the power (No in step S102), the controller 25 of the optical disk device 2 determines whether or not this input operation is to change the channel of the television 3 (step S105). If the input operation is not to change the channel of the television 3 (No in step S105), the controller 25 returns the processing to step S101.

If the input operation is to change the channel of the television 3 (Yes in step S105), the CEC controller 251 turns on the power to the optical disk device 2 (step S106), outputs to the HDMI communication device 22 a CEC command to change the channel of the television 3 (step S107), and advances the processing to step S110. This CEC command is output from the HDMI control terminal 220a to the television 3 via the HDMI cable 6. At this point, if the television 3 has not started up, the power may be switched on to the television 3 such that the television 3 starts up, or the power to the television 3 may be left off.

Next, in step S101, even if no operation has been input to the remote control 4a (No in step S101), if the HDMI communication device 22 receives a CEC command of “system audio mode request” from the television 3 (Yes in step S108), then the CEC controller 251 turns on the power to the optical disk device (step S109) and advances the processing to step S110. Note that the “system audio mode request” is a CEC command that is sent from the television 3 to the HDMI communication device 22 via the HDMI cable 6 when an operation to turn on the power to the television 3 or optical disk device 2 or an operation to change the channel of the television 3 is input to the remote control 4b that is an accessory to the television 3.

In step S110, the CEC controller 251 reads operation setting information from the memory 24. Then, the CEC controller 251 determines whether or not the operation setting information has been set so as to activate the system audio control function defined in the HDMI standard (step S111).

If activation of the system audio control function has been set in the operation setting information read from the memory 24 (Yes in step S111), the CEC controller 251 further determines whether or not the operation setting information has been set so as to start up the optical disk device 2 in an external input mode (step S112). If the start-up in the external input mode has been set in the operation setting information (Yes in step S112), the CEC controller 251 activates the system audio control function and starts up the optical disk device 2 in the external input mode. Then, the system audio control function is utilized to output high quality and impressive audio of the television 3 from the audio speaker 5 (step S113). At this point, furthermore, the CEC controller 251 switches the audio signal to be output to the switching device 253 to the second audio signal that has been externally input from the television 3. The second audio signal is amplified by the amplifier 26 and output from the audio output terminal 260 to the audio speaker 5. Consequently, the optical disk device 2 is actuated as an amplifier device (audio amplification device) which amplifies the externally input second audio signal.

On the other hand, if activation of the system audio control function has not been set in the operation setting information (No in step S111), or if the start-up in an external input mode has not been set in the operation setting information (No in step S112), the CEC controller 251 deactivates the system audio control function and starts up the optical disk device 2 in content reproduction mode. Then, when the optical disk device 2 reproduces the content stored on the optical disk 210, the CEC controller 251 outputs high quality and impressive audio of the content from the audio speaker 5 without utilizing the system audio control function (step S114). At this point, the CEC controller 251 switches the audio signal to be output to the switching device 253 to the first audio signal that has been output from the audio processor 252a. The first audio signal is amplified by the amplifier 26 and output from the audio output terminal 260 to the audio speaker 5. Consequently, the optical disk device 2 is actuated as a content reproduction device.

The above operation allows the HDMI-CEC function to be utilized to actuate the optical disk device 2 in the state intended by the user. Note that in the flowchart of FIG. 2, it is assumed that the power to the optical disk device 2 is off at the start, but the operation can be the same if the power is on.

Moreover, in the present preferred embodiment, an operation was described as preferably being input to the remote control 4a of the optical disk device 2 or the remote control 4b of the television 3, but the present invention is not limited to this, and the optical disk device 2 or the television 3 may also each be equipped with an input device having the same function as the respective remote controls 4a and 4b.

In addition, the audio/video system 1 of the present preferred embodiment preferably includes the optical disk device 2, the television 3, and the audio speaker 5, but the present invention is not limited to this. As long as the present invention includes at least an HDMI-compatible audio/video device including the display 36, it can be used in place of the television 3. Furthermore, as long as the present invention includes at least an HDMI-compatible audio/video device having a content reproduction function which reads content from a removable storage medium or a built-in storage device, and an amplification function which amplifies audio signals, it can be used in place of the optical disk device 2.

The present invention was described above based upon preferred embodiments thereof, but these preferred embodiments are just examples. It will be understood by a person skilled in the art that various modified examples are possible in the various constituent elements and the combination of the various processing, and that these fall within the scope of the present invention.

The present invention can be utilized in DVD players, DVD recorders, BD players, BD recorders, television receivers, home theater systems including these devices, and so forth, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An HDMI-compatible audio/video device comprising:
a content reproduction device that reads content from a removable storage medium or a built-in storage device;
a signal amplification device that amplifies an audio signal and outputs an amplified audio signal to an audio output device;
an audio processor that extracts audio information from the content read by the content reproduction device and outputs the audio information as a first audio signal;
an HDMI communication device that communicates with an external device connected via an HDMI cable;
a storage device that stores operation setting information used to set an operating mode at start-up and to determine whether to activate or deactivate a system audio control function defined in the HDMI standard; and
a CEC controller arranged and programmed such that when the HDMI communication device receives a preset CEC command that is output from the external device when there is a change in a specified state of the external device, if the operation setting information has not been set to activate a system audio control function or to indicate start-up in an external input mode in which a second audio signal that is input from the external device to the HDMI communication device is input in the signal amplification device, then the CEC controller deactivates the system audio control function and starts up the device as a content reproduction device, and if the operation setting information has been set to activate the system audio control function and to indicate start-up in the external input mode, then the CEC controller activates the system audio control function and starts up the device as an audio amplification device.

2. The audio/video device according to claim 1, wherein the change in the specified state of the external device is the start-up of the external device.

3. The audio/video device according to claim 1, wherein the external device is a television receiver, and the change in the specified state of the external device is a channel change of a broadcast signal received by the television receiver.

4. The audio/video apparatus according to claim 1, further comprising a switching device that switches the audio signal to be output to the signal amplification device based on a control signal that is input from the CEC controller, and
when the HDMI communication device receives the preset CEC command, the CEC controller outputs to the switching device a first control signal to output the first audio signal from the switching device to the signal amplification device if the operation setting information has not been set to activate the system audio control function or to indicate start-up in the external input mode, and
the CEC controller outputs to the switching device a second control signal to output the second audio signal from the switching device to the signal amplification device if the operation setting information has been set to activate the system audio control function and to indicate start-up in the external input mode.
